(19) United States
(12) Patent Application Publication
(10) Pub. No.: US 2016/0297227 A1
(43) Pub. Date: Oct. 13, 2016

(54) Printing Blanket for a Printing Cylinder of a Printing Machine, Printing Cylinder Having Said Printing Blanket, and Printing Machine Having Said Printing Cylinder

(71) Applicant: TRELLEBORG COATED SYSTEMS ITALY S.P.A., Milano (IT)

(72) Inventors: Larry Gene Brantley, II, Knoxville, TN (US); Jon Holan, Morristown, TN (US)

(21) Appl. No.: 15/037,703

(22) PCT Filed: Nov. 10, 2014
(86) PCT No.: PCT/EP2014/074170

§ 371 Date: May 19, 2016

(30) Foreign Application Priority Data
Nov. 19, 2013 (IT) MI2013A001918

(51) Int. Cl. B41N 10/04

(52) U.S. Cl. CPC B41N 10/04; B41N 2210/04

(57) ABSTRACT

The printing blanket (1) for a printing cylinder of a printing machine, comprises an elastomeric made top layer (3) having a printing surface (3a), at least one compressible layer (4), and at least a first layer (6) made of non woven fabric.

The present invention relates to printing and coating blankets for offset printing machines, especially but not exclusively of the -Sheet Fed Offset type.

As known to the men skilled in the art, in these printing machines, mounted on the printing cylinder made of metal and rotating around its own axis, is a multi layered product, known in the industry as printing blanket, which covers the exterior surface of the printing cylinder.

A printing blanket is provided with an elastomeric top layer acting as the printing surface, a compressible intermediate layer, and in general one or more woven fabric layers intended to confer the necessary tensile strength and other mechanical properties to the printing blanket. One of the woven fabric layers is usually positioned as the base layer directly in contact to the printing cylinder surface, or indirectly in contact to the printing cylinder surface when a cylinder covering is used to adjust the overall thickness of the installed printing blanket.

Such a kind of printing blanket suffers some drawbacks.

First of all, woven fabric layers used to give the required mechanical properties are quite expensive.

Secondly, woven fabric layers used to give the required mechanical properties are directional, that is to say they offer mechanical properties that can vary depending on direction they are considered.

Thirdly, the process for manufacture of such a kind of printing blanket requires the application of a polymer adhesive to one or more sides of the surface of each woven fabric layer that has to be coupled to an adjacent layer by a subsequent lamination step.

Therefore, the task of the present invention is that of providing a printing blanket, a printing cylinder having such printing blanket, a printing machine having such a printing cylinder, and a process for production of a printing blanket capable of overcoming the drawbacks observed in the known art.

In particular, an objective of the present invention is to provide a printing blanket offering the desired mechanical properties with a substantial reduction of costs.

Another objective of the present invention is to provide a simplified process for manufacturing a printing blanket.

Such objectives are attained, according to the present invention, thanks to a printing blanket for a printing cylinder of a printing machine, comprising an elastomeric top layer having a printing surface, and at least one compressible layer, characterized in that it further comprises at least a first layer made of non woven fabric.

Such a first layer made of non woven fabric can be located in different positions through the multi layered structure of the printing blanket.

Such a first layer made of non woven fabric may be an intermediate layer located between said top layer and a base layer having a contacting surface with the printing cylinder.

Such a first layer made of non woven fabric may be a base layer having a contacting surface with the printing cylinder.

Advantageously each non woven fabric layer can be easily manufactured in spunlace, thermobond, chemobond, wet laydown, weft insertion, or needle punch processes as well as others not detailed at present.

A possible embodiment for the printing blanket foresees a first layer made of non woven fabric and at least a second layer made of non woven fabric.

In such a case both the first and the second layer made of non woven fabric may be intermediate layers separated to each other by other layers comprised in the printing blanket.

As an alternative the first layer made of non woven fabric may be the base layer and the second layer made of non woven fabric may be an intermediate layer.

As a general rule according to the present invention an innovative printing blanket is provided for where one or more layers made of non woven fabric provides sufficient mechanical properties required for the particular printing blanket application requirement: this eliminate the need to design all new blanket applications with one or more woven fabric layers that are used in known printing blankets instead.

Of course, the printing blanket according to the present invention may comprise at least a first woven fabric layer in addition to at least a first non woven fabric layer. A preferred embodiment of the present invention foresees a printing blanket comprising a first woven fabric layer being a base layer having a contacting surface with the printing cylinder, a second woven fabric layer located between said top layer and said compressible layer, said at least a first layer made of non woven fabric being located between said first woven fabric layer and said compressible layer.

In this preferred embodiment the printing blanket also comprises a first adhesive layer at an interface between said top layer and said second woven fabric layer, a second adhesive layer at an interface between said second woven fabric layer and said compressible layer, and a third adhesive layer at an interface between said first non woven fabric layer and said first woven fabric layer.

Advantageously the material of each non woven fabric layer of the printing blanket according to the present invention may by polyester or polyethylene or polyamide or fiberglass or polypropylene or vinyl or polyphenylene or sulphide or aramids or cotton fiber or any combination thereof.

Furthermore each non woven fabric layer of the printing blanket according to the present invention has a thickness value comprised in a range between 0.15 mm and 1.3 mm, preferably between 0.30 mm and 0.50 mm, and a substance value in a range between 50 gr/m² and 120 gr/m² , preferably between 80 gr/m² and 100 gr/m².

Finally, also more than one compressible layer can be provided in the printing blanket according to the present invention, and each of them may be preferably made of a polymeric foam.

The process for manufacturing of a printing blanket according to the present invention is characterized by the use of non woven fabric to make at least one layer thereof.

The manufacturing process is largely simplified in that a non woven fabric layer does not need application of a polymer adhesive to each of its side surface that has to be coupled by lamination with a corresponding adjacent layer of the printing blanket under construction.

Indeed, due to its relatively low density, there is no need to apply an adhesive layer on the non woven fabric layer for its subsequent lamination to an adjacent layer: that is to say an adhesive previously applied only to the adjacent layer may so deeply adhere to the non woven fabric layer to guarantee the necessary resistance to delamination between the non woven fabric layer and said adjacent layer.

These and other aspects will be apparent from the description that follows of a preferred embodiment of the invention, which must be considered a non-limiting example.

The description makes reference to the appended drawings in which:

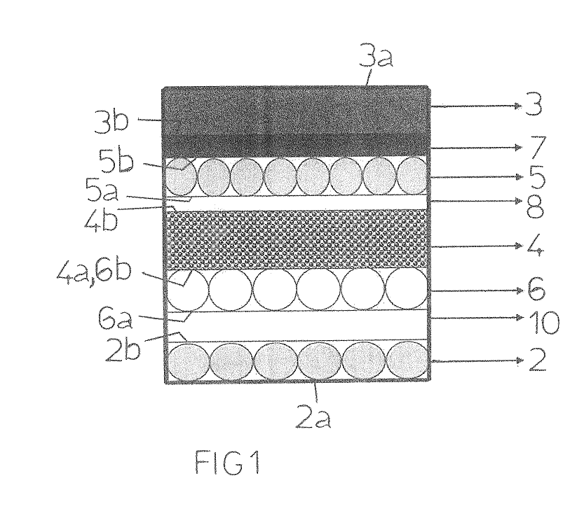

FIG. 1 shows a cross section of a printing blanket according a preferred embodiment of the present invention.

The printing blanket for a printing cylinder of a printing machine, is generally indicated with reference number 1.

The printing blanket 1 has a multi layer structure comprising a base layer 2, a top layer 3, an intermediate compressible layer 4, a woven fabric layer 5 interposed between the top layer 3 and the compressible layer 4, and a non woven fabric layer 6 interposed between the compressible layer 4 and the base layer 2.

The top layer 3 is made of rubber, in this illustrated specific case made of conventional nitrile/butadiene rubber (NBR), and is equipped with an outer printing surface 3a.

The base layer 2 is made of woven fabric and is equipped with a contacting surface 2a destined to contact directly or indirectly a printing cylinder (not shown) when the printing blanket is wrapped around said printing cylinder.

Each woven fabric layer 2, 5 provided for in the printing blanket 1 is in this illustrated specific case made of cotton fibres or a mix of cotton and polyester fibres.

Each woven fabric layer 2, 5 has a substance value preferably in a range between 150 gr/m² and 250 gr/m².

The non woven fabric layer 6 is made of polyester or polyethylene or polyamide or fiberglass or polypropylene or vinyl or polyphenylene or sulphide or aramids or cotton fiber or any combination thereof.

The non woven fabric layer 6 in this illustrated specific case has a thickness value of 0.38 mm and a substance value of 90 gr/m².

The compressible layer 4 is made of a polymeric foam and in this illustrated specific case is made of nitrile butadiene rubber (NBR) modified by adding an expansion agent, with closed cells.

The printing blanket 1 also comprises a first adhesive layer 7 at the interface between the top layer 3 and the woven fabric layer 5, a second adhesive layer 8 at the interface between the woven fabric layer 5 and the compressible layer 4, and a third adhesive layer 10 at the interface between the non woven fabric layer 6 and the base layer 2.

Each adhesive layer 7, 8 and 10 in this illustrated specific case is made of a polymeric adhesive rubber in particular based on nitrile butadiene rubber (NBR).

The present invention discloses use of non woven fabric materials in substitution of some or all woven fabric materials used in a traditional printing blanket.

Non woven materials used in a printing blanket according to the present invention have several advantages over woven fabric materials: they are very less expansive, non directional, and due to their low density can be laminated without being previously coated with an adhesive layer, the latter feature also involving a saving in adhesive material to be used.

In summary, an example way to manufacture the printing blanket requires the following steps.

First of all the adhesive layer 10 is applied to a main face 2b of the woven fabric base layer 2 opposite the contacting surface 2a either by a calendaring process, where the adhesive material is in form a solid tape to be put on said main face 2b of the base layer 2, or by a solvent coating process, where the adhesive material is initially in form of a fluid paste to be spread on said main face 2b of the base layer 2.

Then the non woven layer 6 is laminated with an its first main face 6a on said main face 2b of the woven fabric layer 2 where the adhesive layer 10 was previously applied.

Then the compressible layer 4 is applied with an its first main face 4a to the second main face 6b of the non woven fabric layer 6 by a solvent coating process where the compressible material is initially in form of a fluid paste to be spread on the second main face 6b of the non woven fabric layer 6.

Then the adhesive layer 8 is applied on a first main face 5a of the woven fabric layer 5 either by a calendaring process or by a solvent coating process. Then the woven fabric layer 5 is laminated with its first main face 5a, where the adhesive layer 8 was applied, on the second main face 4b of the compressible layer 4.

The manufacturing steps above referred give rise to a carcass to which the top layer 3 has to be finally joined.

To do so, the adhesive layer 7 is firstly applied on the second main face 5b of the woven fabric layer 5 either by a calendaring process or by a solvent coating process, and then the top layer 2 is laminated, with its main face 3b opposite the printing surface 3a, on said second main face 5b of the woven fabric layer 5 where the adhesive layer 7 was previously applied.

The printing blanket thus conceived is susceptible to various modifications and variants, all falling within the invention concept; furthermore, all details can be replaced by other technically equivalent elements. In practice, the material used, alongside the dimensions, may vary depending on the requirements and the state of art.

1. A printing blanket for a printing cylinder of a printing machine, comprising:
an elastometric top layer having a printing surface; and
at least one compressible layer having at least a first layer made of non-woven fabric.

2. The printing blanket of claim 1, wherein the at least first layer made of non-woven fabric is an intermediate layer located between the elastomeric top layer and a base layer having a contacting surface with the printing cylinder.

3. The printing blanket of claim 1, wherein the at least first layer made of non-woven fabric is a base layer having a contacting surface with the printing cylinder.

4. The printing blanket of claim 1, further comprising at least a first woven fabric layer.

5. The printing blanket of claim 1, further comprising:
a base layer, wherein the base layer is a first woven fabric layer having a contacting surface with the printing cylinder;
a second woven fabric layer located between the top layer and the at least one compressible layer, the at least a first layer made of non-woven fabric being located between the first woven fabric layer and the compressible layer.

6. The printing blanket of claim 5, further comprising:
a first adhesive layer at an interface between the top layer and the second woven fabric layer;
a second adhesive layer at an interface between the second woven fabric layer and the compressible layer; and
a third adhesive layer at an interface between the at least a first layer made of non-woven fabric and the first woven fabric layer.

7. The printing blanket of claim 1, wherein the at least a first fabric layer made of non-woven fabric is made of polyester or polyethylene or polyamide or fiberglass or polypropylene or vinyl or polyphenylene or sulphide or aramids or cotton fiber or any combination thereof.

8. The printing blanket of claim 1, wherein the at least a first fabric layer made of non-woven fabric has a thickness value in a range between 0.30 mm and 0.50 mm, and a substance value in a range between 0.30 mm and 0.50 mm, and a substance value in a range between 80 gr/m² and 100 gr/m².

9. The printing blanket of claim 1, wherein the at least one compressible layer is made of polymeric foam.

10. A printing cylinder of an offset printing machine, coated with the printing blanket of claim 1.

11. A printing machine cylinder having the printing cylinder of claim 10.

12. A process for production of a printing blanket for a printing cylinder of a printing machine, characterized by the use of non-woven fabric to make at least one layer thereof.

13. The process of claim 12, wherein at least a non-woven fabric layer of the printing blanket is directly joined to a compressible layer of the printing blanket without interposition there between of any adhesive layer.

14. The process of claim 12, wherein at least a non-woven fabric layer of the printing blanket is directly laminated, without need for an adhesive layer, to a compressible layer of the printing blanket.
